(19) United States
(12) Patent Application Publication
(10) Pub. No.: US 2024/0346596 A1
(43) Pub. Date: Oct. 17, 2024

(54) System, Method, and Application for Combining Multiple Currency Sources into a Single Account

(71) Applicant: Phillip Glasper, San Francisco, CA (US)

(72) Inventor: Phillip Glasper, San Francisco, CA (US)

(21) Appl. No.: 18/607,822

(22) Filed: Mar. 18, 2024

Related U.S. Application Data
(60) Provisional application No. 63/496,499, filed on Apr. 17, 2023.

(51) Int. Cl. G06Q 40/06; G06Q 20/30

(52) U.S. Cl. CPC G06Q 40/06; G06Q 20/30

(57) ABSTRACT

A currency collaboration platform that provides a mobile application and a website enabling users to combine gift card balances, prepaid debit card balances, and cash/coins into a single account is disclosed. The funds added to the account can be loaded or transferred onto physical cards for use at vendors, or funds can be used for online purchases and can also be invested. The platform includes ATMs for depositing cash/coins and to transfer funds to the account. The platform provides financial guidance to users and account users can speak with specialists for support as well as explore forums, guides, and lessons for information on account management investing, savings, stocks, cryptocurrency, and more.

### CROSS-REFERENCE TO RELATED APPLICATION

The present application claims priority to, and the benefit of, U.S. Provisional Application No. 63/496,499, which was filed on Apr. 17, 2023, and is incorporated herein by reference in its entirety.

### FIELD OF THE INVENTION

The present invention generally relates to the field of financial systems. More specifically, the present invention relates to a novel currency collaboration platform designed to function as a web-based & mobile platform capable of combining gift card balances, prepaid debit card balances, and cash into a single account. The account functions as a digital ‘piggy’ bank to load funds, spend or invest them as desired. ATMs can be used to deposit and withdraw cash & coins, transfer and convert currency between accounts, and buy/withdraw cryptocurrency using digital wallets. The platform provides different educational guides, forums, videos, customer support, financial support from licensed financial coaches and advisors and more within the application enabling users to build their financial growth & education. Accordingly, the present disclosure makes specific reference thereto. Nonetheless, it is to be appreciated that aspects of the present invention are also equally applicable to other similar applications, devices, and methods of manufacture in reference to ATMs, online accounts, and financial infrastructure.

### BACKGROUND

By way of background, in the age of digital banking and gifts, gift cards and prepaid debit cards have become an international essential. Individuals give away gift cards and prepaid debit cards on different occasions and events. Family, friends, and employers often times give gift cards and prepaid debit cards to mark occasions or achievements. In fact, such cards have become a common financial instrument for many individuals. However, a common issue with such cards is the accumulation of low/minimal remaining balances (i.e., a few dollars or less) which are then generally left on these cards after use which may not be sufficient or convenient to use for future purchases. To utilize the low balances on these cards, cardholders often need to first add money, which is not always possible. The inability to spend the remaining balances of the cards can lead to inconvenience and frustration for cardholders. In some cases, the inconvenience associated with using low or unused balances leads to individuals discarding their cards, which results in thousands of dollars each year.

Also, managing multiple cards such as small-value cards is difficult for users, especially without proper financial guidance. This can result in lost opportunities to maximize profits, earning more interest, and more. Both children and adults may lack the necessary financial knowledge, guidance, and support to effectively manage and grow their funds. It is desirable for individuals to accumulate funds of different such cards in a single common account for use, investment, and expenditure.

Denominations of currency such as coins and bills are troublesome to store physically when not in use by the holder and could commonly become stolen, misplaced, or lost. Further, it is difficult and inconvenient to store and manage currency in traditional piggy banks requiring the holder to undo screws, fasteners, or sealing caps meant to “secure the bank” when not calculating progress. Traditional piggy banks take up room space until ready to deposit and are inconvenient for exchanging money. Conventional ATMs do not support coins which is inconvenient for the holder having to buy or create a savings system. Individuals desire a platform that can enable them to store coins in digital currency for effective utilization. Traditional saving methods such as piggy banks are outdated and inefficient, particularly in a digital age spectrum. Piggy banks are unappealing and bulky, especially to the younger generation who are more attuned to digital solutions. Individuals desire a digital platform that can combine the simplicity of traditional saving methods with digital financial management and guidance.

Therefore, there exists a long-felt need in the art for a platform that enables users to combine gift card balances, prepaid debit card balances, cash, coins, stocks, and digital coin wallets into a single account. Additionally, a financial platform that provides a digital ‘piggy’ bank for users of all ages and diversities. Moreover, a system that provides ATMs for depositing coins to convert into digital currency. Further, a financial system that provides financial literacy to users for managing their finances. Furthermore, a system that enables users to manage multiple cards, expenditures, and investments using a mobile application and a website. Also, a system that makes it easy for users to accumulate remaining balances in different prepaid cards in a single account. Finally, there is a need for a financial product that improves financial stability of users by providing financial guidance through various mediums, including expert videos, self-help guides, forums, and personalized tasks and lessons while combining the simplicity of traditional saving methods.

The subject matter disclosed and claimed herein, in one embodiment thereof, comprises a system for accumulating funds from different sources to a unique personalized customer account. The system comprises a mobile application installed in a user device, the mobile application is adapted to display a plurality of interfaces for enabling a user to add funds from a plurality of gift cards and prepaid debit cards to a finance account. The funds from the finance account can be used for investing and purchasing both offline and online. Coins and bills in the form of funds can be added to the finance account using an ATM. The system also provides financial guidance for users by providing financial guides, lessons, forums, and interaction with financial experts.

In this manner, the finance platform and account of the present invention accomplishes all of the foregoing objectives and provides users with a currency collaboration platform designed to function as a web-based platform that can combine gift card balances, prepaid debit card balances, cash, and coins into a single account. The platform includes physical ATMs to withdraw and deposit coins. The system enables users to become financially educated through different educational guides, forums, and experts in order to develop, build, or fix credit and more.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a system for accumulating funds from different sources to a unique account. The system comprises a mobile application installed in a user device, the mobile application is adapted to display a plurality of interfaces for enabling a user to add funds from a plurality of gift cards and prepaid debit cards to a finance account, the funds from the finance account can be used for investing and purchasing. Coins and bills in the form of funds can be added to the finance account using an ATM.

In yet another embodiment, the mobile application provides a first user interface for receiving user login credentials, a second user interface for receiving funds to add to the financial account, a third user interface for financial guidance information in the form of an expert call, guides, lessons, forums and more, and a fourth user interface for investing and spending the funds added in the financial account.

In another aspect, the mobile application and the website displays a currency collaboration interface which includes a plurality of fund sources, a balance indicator for each fund source showing the balance in the fund source, a means for enabling transfer balance from each fund source to a unique account of the user, the funds loaded into the unique account is used for spending or investment. The interface provides functionality for users to add or delete fund sources, including, but not limited to, gift card balances, prepaid debit card balances, and cash/coins added through an ATM. The currency collaboration interface also includes a currency exchange for exchanging one currency (i.e., domestic) to another currency (i.e., foreign), and/or for developing a credit building system.

In yet another aspect, a user interface is displayed which is configured to display video content featuring financial experts providing advice to a user, a guide link for providing access to different self-help books, a forums link for facilitating collaboration among users, a tasks link for providing a summary of the user's pending and completed tasks, and a lessons link for providing video lessons access to specific financial queries raised by the users. The user interface loaded onto a mobile phone enables customers to open/manage accounts on the go or at home. The mobile phone having a camera enables customers to view live agents and to chat/interact using the accessible keyboard on the phone screen. The dialogue of the live agent can be dictated to text (i.e., speech-to-text) on the screen of the phone for reading. The text enables customers with speech and hearing difficulty to read what the speaker is saying, or to maintain privacy of information when the customer is in public (i.e., to protect financial account information).

In another embodiment, a ‘PIGI banking’ system is disclosed. The ‘PIGI banking’ system includes a mobile application and a website, a server, the server is accessible through the mobile application and the website via a communication network. The mobile application facilitates a user to select one or more fund sources to add funds to a ‘piggy’ account and also facilitates the user to invest or spend the added funds from the ‘piggy’ or financial account. An ATM is coupled with the ‘piggy’ or financial account wherein the ATM is used for depositing funds in the form of coins and bills and transferring funds from the one or more fund sources to the ‘piggy’ or financial account.

In yet another embodiment, a computer-implemented currency collaboration platform is disclosed. The platform includes a server, a mobile application, and a website for user interaction with the platform. The server includes an account database for managing user accounts, a currency source database for storing and converting fund sources, a financial expert database for storing details of financial experts, a financial information database for storing finance self-help information, and wherein the platform enables users to integrate funds from one or more sources to a ‘piggy’ account. The integrated funds enable customers to exchange currency from one currency to another in order to ‘internationalize’ money conversion for leisure or travel.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of a currency collaboration platform of the present invention in accordance with the disclosed architecture;

FIG. 2 illustrates an exemplary user interface showing the first/initial page displayed to a user in accordance with one embodiment of the present invention;

FIG. 3 illustrates another user interface displayed by the application and the website in accordance with one embodiment of the present invention;

FIG. 4 illustrates a currency collaboration interface displayed by the application and website in accordance with one embodiment of the present invention;

FIG. 5 illustrates an exemplary user interface for providing customer support, financial education, and investing options to users of the system in accordance with one embodiment of the present invention;

FIG. 6 illustrates a user interface showing options of investing and spending money from the ‘piggy’ or financial account offered by the ‘PIGI banking’ system in accordance with one embodiment of the present invention; and

FIG. 7 illustrates an exemplary ATM that works in conjunction with the website and the application (i.e., mobile app) offered by the ‘PIGI banking’ system of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a platform that enables users to combine gift card balances, prepaid debit card balances, cash & coins into a single account. Additionally, a financial platform that provides a digital ‘piggy’ bank for users. Moreover, for a system that provides ATMs for depositing cash and coins to convert into digital currency. Further, a financial system that provides financial literacy to users for managing their finances. Furthermore, a system that enables users to manage multiple cards, expenditures, and investments using a mobile application and a website. Also, for a system that makes it easy for users to accumulate remaining balances in different prepaid cards in a single account. Finally, there is a long-felt need in the art for a financial product that improves financial stability of users by providing financial guidance through various mediums, including expert videos, self-help guides, forums, and personalized tasks and lessons while combining the simplicity of traditional saving methods.

The present invention, in one exemplary embodiment, is a computer-implemented currency collaboration system. The system includes a server, a mobile application, and a website for user interaction with the system. The server includes an account database for managing user accounts, a currency source database for storing fund sources, a financial expert database for storing details of financial experts, a financial information database for storing finance self-help information, and wherein the platform enables users to integrate funds from one or more sources to a single ‘piggy’ account.

The system of the present invention enables users to accumulate funds from various sources, such as gift cards, prepaid debit cards, coins, and cash/bills, into a single, unique account also referred to as a ‘piggy’ account. The centralization helps financial management by consolidating multiple balances in one place. The mobile application and website interfaces facilitate the easy addition of funds from different sources. Funds can also be added from physical currency through ATMs, enhancing convenience. Funds accumulated in the ‘piggy’ or financial account can be used for various purposes, including investing, and purchasing. The system provides financial guidance through expert calls, guides, lessons, and forums to enable users to make informed financial decisions.

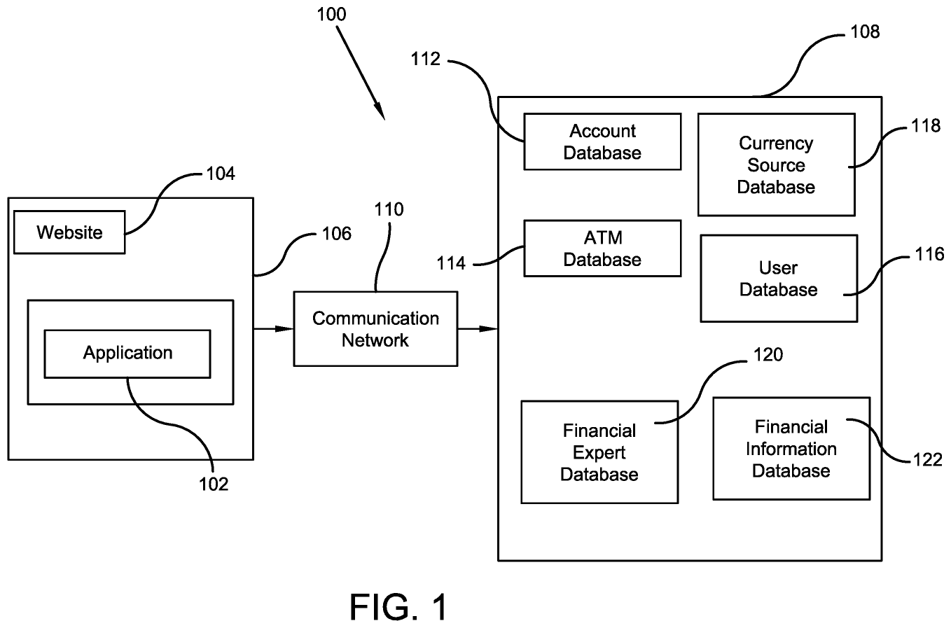

Referring initially to the drawings, FIG. 1 illustrates a schematic view of the currency collaboration platform of the present invention in accordance with the disclosed architecture. The currency collaboration platform 100 of the present invention is designed as a financial platform that integrates different sources of currency into a single, manageable account. The platform 100 is computer-implemented and is accessible both as a web-based service and a mobile application to enable users to manage their finances on the go, using the device of their choice. More specifically, the currency collaboration platform 100 includes a mobile application 102 and a website 104 for accessing functionalities offered by the platform system 100. A user device 106 which can be a handheld electronic device or any other computing device can be used for accessing mobile application 102 and the website 104.

Preferably, the platform 100 has a client-server architecture where a plurality of users function as clients to access functionalities offered by a server 108. The server 108 can be a centralized server, distributed server, cloud server, or any other conventional server. Clients can access the server 108 using the corresponding user device 106 via a communication network 110. The platform 100 manages a unique account (also referred to as a ‘piggy’ account) for each user wherein the user can integrate currency from different sources into the account.

The communication network 110 can be one or more types of wireless communication signals and/or systems, for example, radio frequency (RF), infrared (IR), frequency-division multiplexing (FDM), orthogonal FDM (OFDM), time-division multiplexing (TDM), time-division multiple access (TDMA), extended TDMA (E-TDMA), wideband CDMA (WCDMA), CDMA 2000, discrete multi-tone (DMT), Bluetooth (®), global positioning system (GPS), Wi-Fi, ZigBee (™), global system for mobile communication (GSM), 2G, 2.5G, 3G, 3.5G, 4G, 5G, 6G, or the like.

The server 108 includes an account database 112 for storing details of all the ‘piggy’ or financial accounts maintained by the platform system 100. Each account is uniquely associated with a registered user of the system 100. An ATM database 114 is included in the server 108 for storing details of all the specialized ATMs established as a part of the platform 100. The platform 100 includes a plurality of ATMs for facilitating the deposit and withdrawal of funds from the ‘piggy’ or financial accounts. The ATMs provide blending of the traditional banking facilities with modern digital finance, thereby enhancing user accessibility. The mobile application 102 and the website 104 can enable contactless ATM access for users/customers to go through their account, navigate to ‘find ATM’ (i.e., physical ATM).

A user database 116 is adapted to store profiles of the registered users. The profile can include name, location, age, gender, and more. Further, the user database 116 is also used for authentication of a user before accessing the platform 100 on the mobile application 102 and the website 104. The authentication feature can include a variety of safety questions that must be answered before an account can be accessed or before speaking with an agent. Alternatively, the authentication feature can include a facial recognition or a thumbprint verification. Agents can have the ability to pause accounts, future transactions, cards, and/or account interactions until authentication is performed. A currency/funds source database 118 is used for storing information of different sources of currency for a user. The different sources can include a gift card, prepaid debit card, cash/coin sources, and more. In the present invention, a registered user can add multiple sources for integrated currency into the ‘piggy’ or financial account, therefore, the platform 100 maintains real-time transaction information and updates in the currency source database 118 and the account database 112.

The currency collaboration platform 100 enables users to discuss with financial experts for investments, savings, stocks, and more. A financial experts database 120 is included in the server 108 for storing details of different financial experts registered with the platform 100. Each financial expert can be automatically selected based on the query of a user or can also be manually selected for financial guidance. Financial guidance can include online live or recorded training seminars viewable on a mobile phone or a computing device. A financial information database 122 is designed for storing different guides, forums, video and audio lessons, market information, and more for enabling users to make an informed decision on saving and investing the money using the financial platform 100. The financial information database 122 can include functionality to learn, access, and invest in the stock markets.

The ‘PIGI banking’ platform 100 is a comprehensive financial platform that simplifies managing different currency sources and educates and supports users in their financial journey. Also, unused balances of different prepaid accounts and cards can be accumulated in a single account. The account can be used as a PIGI bank by both children and adults. The platform 100 and integrated funds enable customers to exchange currency from one currency to another in order to ‘internationalize’ money conversion. The platform 100 enables customers to exchange currency from a domestic currency to a foreign currency. The platform 100 can include an exchange tab for a customer to select ‘from’ currency to ‘to’ currency.

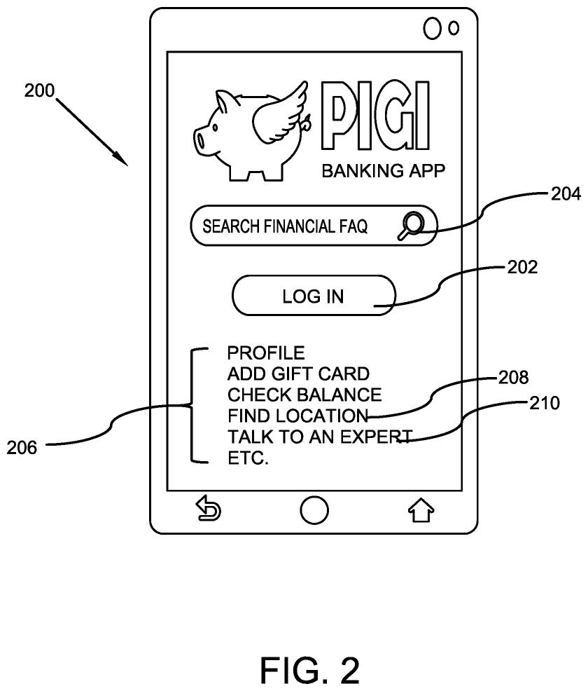

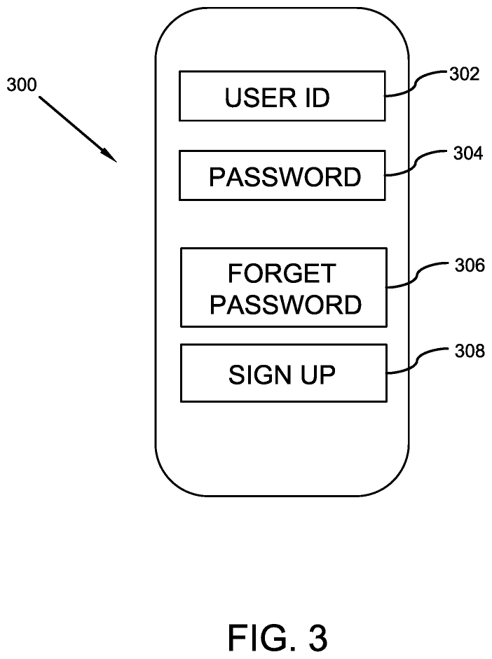

FIG. 2 illustrates an exemplary user interface showing the first/initial page displayed to a user in accordance with one embodiment of the present invention. The initial interface 200 is displayed by the mobile application 102 and the website 104 and provides a login option 202 for enabling the user to sign into the application 102. The login option 202 provides access to another user interface 300 as illustrated in FIG. 3. The home page 200 also provides a search bar 204 for enabling a user to input a query which can be related to any financial aspect or on a particular feature offered by the system 100. The user can input the query using an input device (such as a keypad, touchscreen, or voice command) and the results are displayed to the user for easy accessibility. The results in response to the query can be retrieved from the financial information database 122 and can also be retrieved from the general internet depending on the implementation of the platform 100.

A plurality of options 206 are also offered by the home page 200. Some of the features may require the user to login to the system 100 but other features such as “Find Location” 208 and “Talk to an expert” 210 may not require any login and can be publicly available to the user. Depending on the design of the mobile application 102 and the website 104, the layout of the page 200 can vary.

FIG. 3 illustrates another user interface displayed by the application and the website in accordance with one embodiment of the present invention. The user interface 300 displays a user ID input box 302 and a password input box 304 for enabling a user to log into the platform 100. The information received by the platform 100 is verified by the platform 100 for authenticating the user. In cases when the user forgets the password, a forget password option 306 is provided to the user and a signup option 308 is also available for enabling a new user to sign up to the system 100 to become a registered user of the system 100.

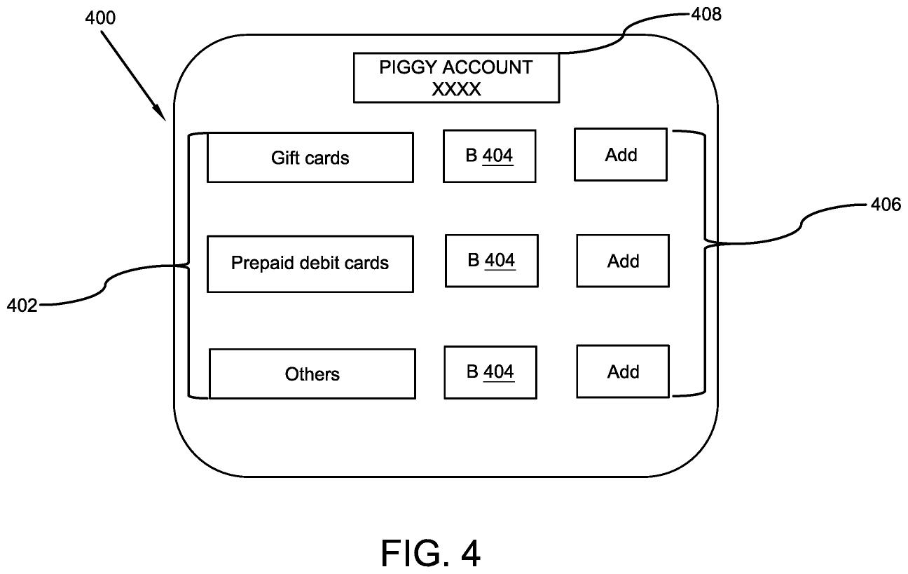

FIG. 4 illustrates a currency collaboration interface displayed by the application and website in accordance with one embodiment of the present invention. The currency collaboration interface 400 displays a plurality of currency/fund sources 402 added by the user in the system 100. Balance 404 corresponding to each source is also displayed on the interface 400. An “Add” option 406 for each source enables the user to add the balance to the ‘piggy’ or financial account 408 of the user from the respective currency source. The interface 400 enables easy management of different currency sources for a centralized storage into the ‘piggy’ or financial account 408. The loaded funds of the ‘piggy’ or financial account 408 can be spent or invested easily by a user and enables users to accumulate and collaborate even low or unused balances from different sources. The sources can be added or deleted by the user as per their preferences and requirements and can include gift card balances, prepaid debit card balances, cash/coins added through an ATM, and more.

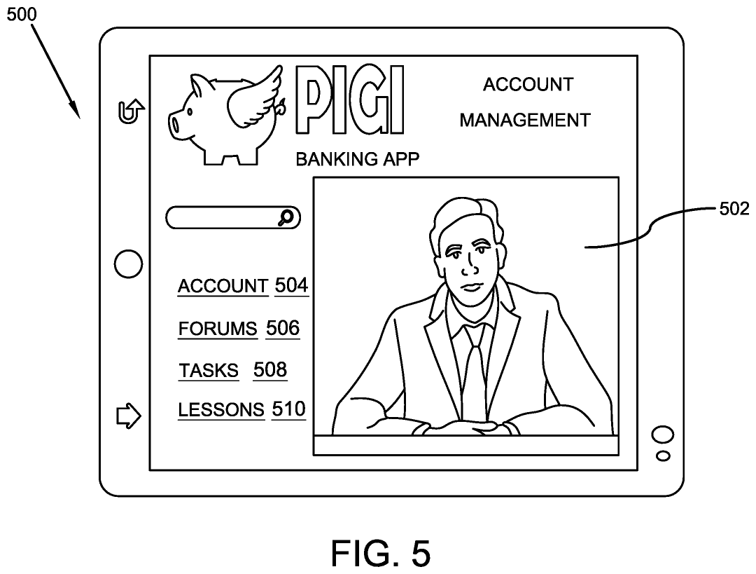

FIG. 5 illustrates an exemplary user interface for providing customer support, financial education, and investing options to users of the system in accordance with one embodiment of the present invention. The system 100 enables registered users to talk to experts/customer support for financial guidance and thus making informed decisions. As illustrated, the user interface 500 displays video 502 of an expert providing financial advice to a registered user. The video 502 can be a live video or alternatively can be a recorded video. Further, the user can have the option of a video call or an audio call with an expert.

A Guides link 504 provides different self-help financial guides linked to the query asked by the user using the query bar 204. The guides may include textual guides, interactive books, and animated books. The platform 100 hosts a plurality of forums for collaboration among users and one or more forums can be accessed using the Forums link 506. A Tasks link 508 provides a snapshot of pending and completed tasks of the user and may also provide transaction history of the user on the platform 100. The tasks can also be related to the pending authentication documents upload and more. For video lessons related to a specific query, one or more lessons can be accessed using the Lessons link 510.

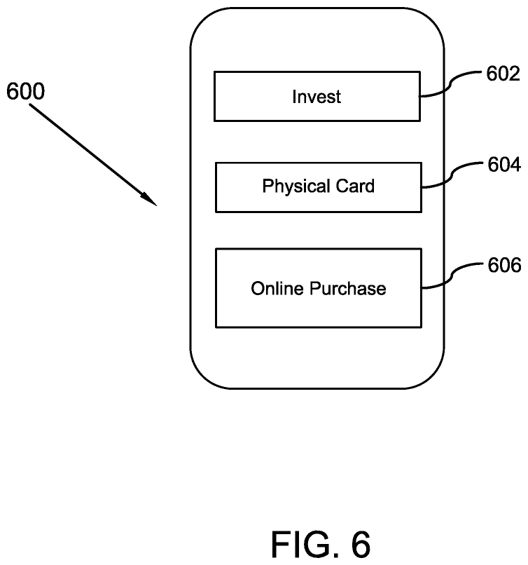

FIG. 6 illustrates a user interface showing options of investing and spending money from the ‘piggy’ or financial account offered by the ‘PIGI banking’ system in accordance with one embodiment of the present invention. The funds accumulated in the PIGI bank account can be invested and can be spent by a user, thereby facilitating easy management of the money. More specifically, the user interface 600 provides an Invest option 602 for enabling the user to invest money in a plurality of options such as mutual funds and other financial instruments. A Physical card option 604 is used for transferring funds from the ‘piggy’ or financial account to a physical card which can be offered by the ‘PIGI banking’ system 100 of the present invention. The physical cards can be used at vendors and can be similar to existing credit cards and debit cards.

An Online purchase option 606 enables the user to use the funds for online purchasing. It will be noted that in some embodiments of the present invention, an upper limit can be set on the funds for each option 602, 604, 606.

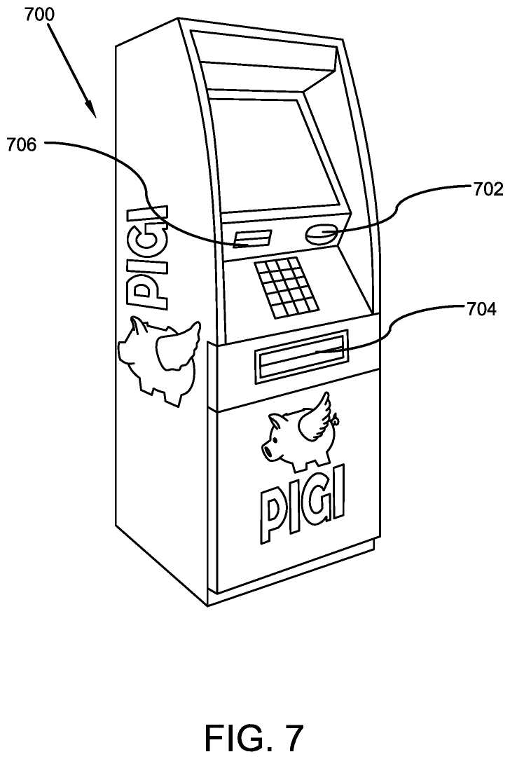

FIG. 7 illustrates an exemplary ATM that works in conjunction with the website and the application offered by the ‘PIGI banking’ system of the present invention in accordance with the disclosed structure. The ATM 700 is a customized ATM and includes a coin inlet 702 for enabling a user to deposit coins. Cash can also be deposited using the cash inlet 704. The funds deposited through the ATM 700 are directly deposited in the ‘piggy’ or financial account associated with the user and can be used as described in FIG. 6. A balance protector feature can be used at the ATM to protect unauthorized viewing of an account balance at the site of the ATM. The balance protector option enables the user to request that their account balance be transmitted/sent to another device rather than displayed on the screen of the ATM. For example, the balance protector option enables the user to have their account balance be transmitted to a selected remote device such as a smartphone, smartwatch, or other remote computing device.

The ATM 700 also provides a card slot 706 to insert gift card, prepaid debit card, and other similar cards to enable a user to transfer the funds from the inserted card to the associated ‘piggy’ account. The transferred fund is reflected in the application 102 and the website 104 and enables the user to use as per FIG. 6.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “‘PIGI banking’ platform”, “financial platform”, “currency collaboration platform”, “platform system”, and “system” are interchangeable and refer to the computer-implemented currency collaboration system 100 of the present invention.

Notwithstanding the foregoing, the computer-implemented currency collaboration system 100 of the present invention can be of any suitable size and configuration as is known in the art without affecting the overall concept of the invention, provided that it accomplishes the above-stated objectives. One of ordinary skill in the art will appreciate that the computer-implemented currency collaboration system 100 as shown in the FIGS. are for illustrative purposes only, and that many other configurations of the computer-implemented currency collaboration system 100 can be included in the present invention.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A financial integration platform for integrating different sources of currency, the financial integration platform comprising:
a mobile application;
a website;
a server;
a communication network; and
a user device to manage a first financial account;
wherein said website having a web-based service;
wherein said financial integration platform is accessible through said web-based service and said mobile application to enable a user to manage at least said first financial account;
wherein said user device is an electronic device for accessing said mobile application and said website;
wherein said server accessible by a plurality of users;
wherein said server is selected from the group consisting of a centralized server, a distributed server, and a cloud server;
wherein said plurality of users access said server through said user device and said communication network;
wherein said financial integration platform having a financial account associated with each one of said plurality of users for integrating multiple sources of currency; and
further wherein said multiple sources of currency including deposits from the group consisting of gift card balances, prepaid debit card balances, cash, and coins.

2. The financial integration platform of claim 1, wherein said server having an account database for storing information of said at least said first financial account maintained by said financial integration platform.

3. The financial integration platform of claim 2 further comprising a plurality of ATMs having an ATM database connected to said server, wherein said plurality of ATMs accept said deposits of said multiple sources of currency.

4. The financial integration platform of claim 3, wherein said plurality of ATMs dispense a withdrawal from said at least said first financial account of said each one of said plurality of users.

5. The financial integration platform of claim 4 further comprising a user database for storing a user profile of said each one of said plurality of users, wherein said user profile having information selected from the group consisting of a name, a location, an age, a gender, and an authentication.

6. The financial integration platform of claim 5, wherein said deposits from said gift cards include an unused balance of each one of said gift cards.

7. The financial integration platform of claim 5, wherein said deposits from said prepaid debit cards include an unused balance of each one of said prepaid debit cards.

8. The financial integration platform of claim 4, wherein each one of said plurality of ATMs having a coin inlet and a cash inlet.

9. The financial integration platform of claim 1, wherein said financial integration platform is accessible through said web-based service and said mobile application to enable a user to transfer funds from said at least said first financial account to a second financial account.

10. The financial integration platform of claim 9, wherein said second financial account is an investment account.

11. A financial integration platform for integrating different sources of currency, the financial integration platform comprising:
a mobile application;
a website;
a server;
a communication network;
a user device to manage a first financial account; and
a plurality of ATMs;
wherein said plurality of ATMs having an ATM database connected to said server;
wherein said website having a web-based service;
wherein said financial integration platform is accessible through said web-based service and said mobile application to enable a user to manage at least said first financial account;
wherein said user device is an electronic device for accessing said mobile application and said website;
wherein said server accessible by a plurality of users;
wherein said server is selected from the group consisting of a centralized server, a distributed server, and a cloud server;
wherein said plurality of users access said server through said user device and said communication network;
wherein said financial integration platform having a financial account associated with each one of said plurality of users for integrating multiple sources of currency;
wherein said multiple sources of currency including deposits from the group consisting of gift card balances, prepaid debit card balances, cash, and coins; and
further wherein said plurality of ATMs accept said deposits of said multiple sources of currency.

12. The financial integration platform of claim 11, wherein each one of said plurality of ATMs having a coin inlet and a cash inlet.

13. The financial integration platform of claim 11, wherein said server having an account database for storing information of said at least said first financial account maintained by said financial integration platform.

14. The financial integration platform of claim 11, wherein said plurality of ATMs dispense a withdrawal from said at least said first financial account of said each one of said plurality of users.

15. The financial integration platform of claim 11 further comprising a user database for storing a user profile of said each one of said plurality of users, wherein said user profile having information selected from the group consisting of a name, a location, an age, a gender, and an authentication.

16. The financial integration platform of claim 11, wherein said deposits from said gift cards include an unused balance of each one of said gift cards.

17. The financial integration platform of claim 11, wherein said deposits from said prepaid debit cards include an unused balance of each one of said prepaid debit cards.

18. A financial integration platform for integrating different sources of currency, the financial integration platform comprising:
a mobile application;
a website;
a server;
a communication network;
a user device to manage a first financial account; and
a plurality of ATMs;
wherein said plurality of ATMs having an ATM database connected to said server;
wherein said website having a web-based service;
wherein said financial integration platform is accessible through said web-based service and said mobile application to enable a user to manage at least said first financial account;
wherein said user device is an electronic device for accessing said mobile application and said website;
wherein said server accessible by a plurality of users;
wherein said server is selected from the group consisting of a centralized server, a distributed server, and a cloud server;
wherein said plurality of users access said server through said user device and said communication network;
wherein said financial integration platform having a financial account associated with each one of said plurality of users for integrating multiple sources of currency;
wherein said multiple sources of currency including deposits from the group consisting of gift card balances, prepaid debit card balances, cash, and coins;
wherein said plurality of ATMs accept said deposits of said multiple sources of currency;
wherein said deposits from said gift cards include an unused balance of each one of said gift cards;
wherein said deposits from said prepaid debit cards include an unused balance of each one of said prepaid debit cards; and
further wherein each one of said plurality of ATMs having a coin inlet and a cash inlet.

19. The financial integration platform of claim 18, wherein said financial integration platform is accessible through said web-based service and said mobile application to enable a user to send information from said at least said first financial account from said plurality of ATMs to said user device.

20. The financial integration platform of claim 19, wherein said financial integration platform having a user interface for displaying an expert providing financial advice to said user.
